(19) United States
(12) Patent Application Publication
(10) Pub. No.: US 2017/0191417 A1
(43) Pub. Date: Jul. 6, 2017

(54) ENGINE COMPONENT ASSEMBLY

(71) Applicant: General Electric Company, Schenectady, NY (US)

(72) Inventors: Ronald Scott Bunker, West Chester, OH (US); Robert Frederick Bergholz, Loveland, OH (US); Jason Randolph Allen, Loveland, OH (US); Robert David Briggs, West Chester, OH (US); Byron Andrew Pritchard, JR., Loveland, OH (US); Kevin Robert Feldmann, Mason, OH (US); Curtis Walton Stover, Mason, OH (US); Zachary Daniel Webster, Mason, OH (US); Fernando Reiter, Reading, OH (US); Michael Alan Meade, Liberty Township, OH (US)

(21) Appl. No.: 14/989,290

(22) Filed: Jan. 6, 2016

(51) Int. Cl. F02C 7/12; F23R 3/00; F01D 5/14; F01D 25/24; F01D 25/08; F01D 9/04

(52) U.S. Cl. CPC F02C 7/12; F01D 25/08; F01D 9/041; F01D 5/147; F01D 25/24; F23R 3/002; F05D 2220/32; F05D 2260/22141

(57) ABSTRACT

An engine component assembly includes a first engine component having a hot surface in thermal communication with a hot combustion gas flow and a cooling surface, and a second engine component having a first surface in fluid communication with a cooling fluid flow and a second surface spaced from the cooling surface to define a space. A cooling aperture extends through the second engine component. A cooling feature extends from the cooling surface of the first engine component, and is oriented relative to the cooling aperture such that the cooling fluid flow is orthogonal and non-orthogonal to different portions of the cooling feature.

### BACKGROUND OF THE INVENTION

Turbine engines, and particularly gas or combustion turbine engines, are rotary engines that extract energy from a flow of combusted gases passing through the engine onto a multitude of turbine blades. Gas turbine engines have been used for land and nautical locomotion and power generation, but are most commonly used for aeronautical applications such as for airplanes, including helicopters. In aircraft, gas turbine engines are used for propulsion of the aircraft. In terrestrial applications, turbine engines are often used for power generation.

Gas turbine engines for aircraft are designed to operate at high temperatures to maximize engine efficiency, so cooling of certain engine components, such as the high pressure turbine and the low pressure turbine, may be necessary. Typically, cooling is accomplished by ducting cooler air from the high and/or low pressure compressors to the engine components which require cooling. Temperatures in the high pressure turbine are around 1000° C. to 2000° C. and the cooling air from the compressor is about 500 to 700° C. While the compressor air is at a high temperature, it is cooler relative to the turbine air, and may be used to cool the turbine. When cooling the turbines, cooling air may be supplied to various turbine components, including the interior of the turbine blades and the turbine shroud. Other engine components that may be cooled include nozzles, vanes, combustor liners, or combustor deflectors.

Engine components have been cooled using different methods, including conventional convection cooling and impingement cooling. In conventional convection cooling, cooling air flows along a cooling path through the component, and heat is transferred into the flowing air. In impingement cooling, a cooling surface, typically an inner surface, of the component is impinged with high velocity air in order to transfer more heat by convection than with typical convection cooling.

Particles, such as dirt, dust, sand, and other environmental contaminants, in the cooling air can cause a loss of cooling and reduced operational time or “time-on-wing” for the aircraft environment. This problem is exacerbated in certain operating environments around the globe where turbine engines are exposed to significant amounts of airborne particles. In the most severe cases the entire cooling surface of the shroud becomes coated with particles, with the additional negative impact of film hole blockage.

### BRIEF DESCRIPTION OF THE INVENTION

In one aspect, the invention relates to an engine component assembly having a first engine component having a hot surface in thermal communication with a hot combustion gas flow and a cooling surface, with the cooling surface being different than the hot surface, a second engine component having a first surface in fluid communication with a cooling fluid flow and a second surface, different from the first surface, spaced from the cooling surface and defining a space between the second surface and the cooling surface, at least one cooling aperture defining a centerline and extending through the second engine component from the first surface to the second surface and defining a cooling fluid flow path, and at least one cooling feature extending from the cooling surface of the first engine component and having a body with a perimetral wall terminating in a peak. The body is oriented relative to the centerline such that the centerline is orthogonal to the peak and non-orthogonal to at least a portion of perimetral wall.

In another aspect, the invention relates to an engine component assembly having a first engine component having a hot surface in thermal communication with a hot combustion gas flow and a cooling surface, with the cooling surface being different than the hot surface, a second engine component having a first surface in fluid communication with a cooling fluid flow and a second surface, different from the first surface, spaced from the cooling surface and defining a space between the second surface and the cooling surface, at least one cooling aperture extending through the second engine component from the first surface to the second surface and defining a cooling fluid flow path defining a cooling fluid streamline, and at least one cooling feature extending from the cooling surface of the first engine component and comprising a body defining a body axis and having a perimetral wall. The body is oriented relative to the cooling fluid flow path such that the cooling fluid streamline is orthogonal to the body axis and non-orthogonal to at least a portion of perimetral wall.

### BRIEF DESCRIPTION OF THE DRAWINGS

In the drawings:

FIG. 1 is a schematic cross-sectional diagram of a gas turbine engine for an aircraft.

FIG. 2 is a schematic view showing a generic engine component assembly of the engine from FIG. 1 according to a first embodiment of the invention.

FIG. 3 is a close-up view of a portion of FIG. 2.

FIG. 4 is a perspective view of a cooling surface of a first engine component of the engine component assembly from FIG. 2.

FIG. 5 is a plan view of some exemplary arrays of cooling features for the first engine component of the engine component assembly from FIG. 2.

FIG. 6 is a schematic cross-sectional view of a generic engine component assembly according to a second embodiment of the invention.

FIG. 7 is a perspective view of a cooling surface of a first engine component from FIG. 6.

FIG. 8 is a schematic cross-sectional view of a generic engine component assembly according to a third embodiment of the invention.

FIG. 9 is a perspective view of a cooling surface of a first engine component from FIG. 8.

FIG. 10 is a schematic cross-sectional view of a generic engine component assembly according to a fourth embodiment of the invention.

FIG. 11 is a perspective view of a cooling surface of a first engine component from FIG. 10.

### DESCRIPTION OF EMBODIMENTS OF THE INVENTION

The described embodiments of the present invention are directed to cooling an engine component, particularly in a turbine engine. For purposes of illustration, the present invention will be described with respect to an aircraft gas turbine engine. It will be understood, however, that the invention is not so limited and may have general applicability in non-aircraft applications, such as other mobile applications and non-mobile industrial, commercial, and residential applications.

As used herein, the terms “axial” or “axially” refer to a dimension along a longitudinal axis of an engine. The term “forward” used in conjunction with “axial” or “axially” refers to moving in a direction toward the engine inlet, or a component being relatively closer to the engine inlet as compared to another component. The term “aft” used in conjunction with “axial” or “axially” refers to a direction toward the rear or outlet of the engine relative to the engine centerline.

As used herein, the terms “radial” or “radially” refer to a dimension extending between a center longitudinal axis of the engine and an outer engine circumference. The use of the terms “proximal” or “proximally,” either by themselves or in conjunction with the terms “radial” or “radially,” refers to moving in a direction toward the center longitudinal axis, or a component being relatively closer to the center longitudinal axis as compared to another component. The use of the terms “distal” or “distally,” either by themselves or in conjunction with the terms “radial” or “radially,” refers to moving in a direction toward the outer engine circumference, or a component being relatively closer to the outer engine circumference as compared to another component.

All directional references (e.g., radial, axial, proximal, distal, upper, lower, upward, downward, left, right, lateral, front, back, top, bottom, above, below, vertical, horizontal, clockwise, counterclockwise) are only used for identification purposes to aid the reader's understanding of the present invention, and do not create limitations, particularly as to the position, orientation, or use of the invention. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other. The exemplary drawings are for purposes of illustration only and the dimensions, positions, order and relative sizes reflected in the drawings attached hereto may vary.

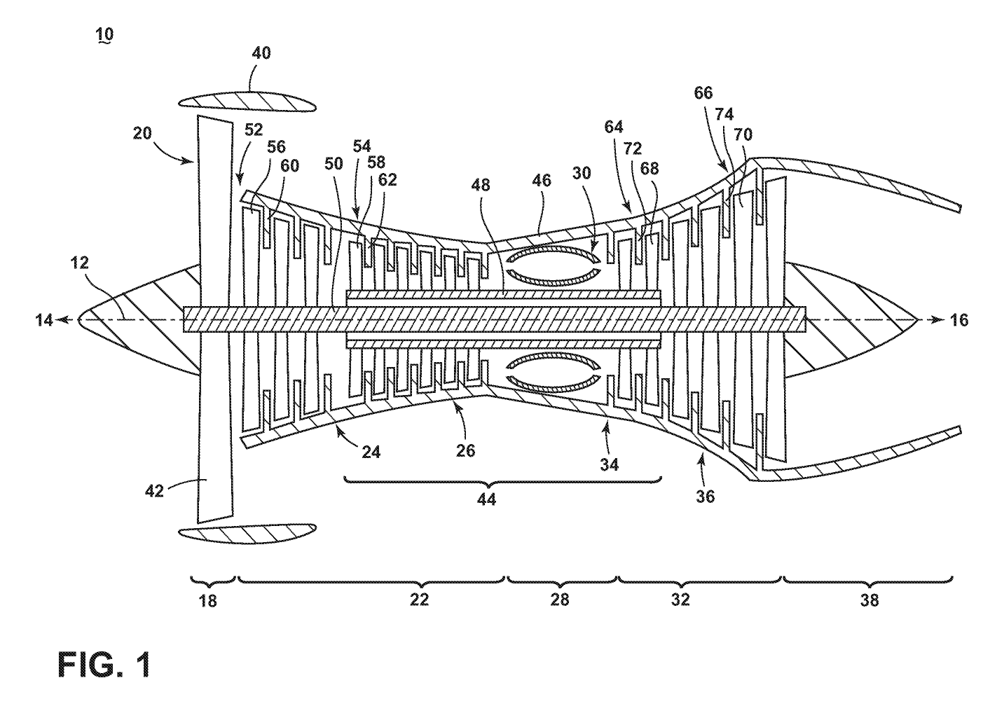

FIG. 1 is a schematic cross-sectional diagram of a gas turbine engine 10 for an aircraft. The engine 10 has a generally longitudinally extending axis or centerline 12 extending forward 14 to aft 16. The engine 10 includes, in downstream serial flow relationship, a fan section 18 including a fan 20, a compressor section 22 including a booster or low pressure (LP) compressor 24 and a high pressure (HP) compressor 26, a combustion section 28 including a combustor 30, a turbine section 32 including a HP turbine 34, and a LP turbine 36, and an exhaust section 38.

The fan section 18 includes a fan casing 40 surrounding the fan 20. The fan 20 includes a plurality of fan blades 42 disposed radially about the centerline 12.

The HP compressor 26, the combustor 30, and the HP turbine 34 form a core 44 of the engine 10 which generates combustion gases. The core 44 is surrounded by core casing 46 which can be coupled with the fan casing 40.

A HP shaft or spool 48 disposed coaxially about the centerline 12 of the engine 10 drivingly connects the HP turbine 34 to the HP compressor 26. A LP shaft or spool 50, which is disposed coaxially about the centerline 12 of the engine 10 within the larger diameter annular HP spool 48, drivingly connects the LP turbine 36 to the LP compressor 24 and fan 20.

The LP compressor 24 and the HP compressor 26 respectively include a plurality of compressor stages 52, 54, in which a set of compressor blades 56, 58 rotate relative to a corresponding set of static compressor vanes 60, 62 (also called a nozzle) to compress or pressurize the stream of fluid passing through the stage. In a single compressor stage 52, 54, multiple compressor blades 56, 58 may be provided in a ring and may extend radially outwardly relative to the centerline 12, from a blade platform to a blade tip, while the corresponding static compressor vanes 60, 62 are positioned downstream of and adjacent to the rotating blades 56, 58. It is noted that the number of blades, vanes, and compressor stages shown in FIG. 1 were selected for illustrative purposes only, and that other numbers are possible.

The HP turbine 34 and the LP turbine 36 respectively include a plurality of turbine stages 64, 66, in which a set of turbine blades 68, 70 are rotated relative to a corresponding set of static turbine vanes 72, 74 (also called a nozzle) to extract energy from the stream of fluid passing through the stage. In a single turbine stage 64, 66, multiple turbine blades 68, 70 may be provided in a ring and may extend radially outwardly relative to the centerline 12, from a blade platform to a blade tip, while the corresponding static turbine vanes 72, 74 are positioned upstream of and adjacent to the rotating blades 68, 70. It is noted that the number of blades, vanes, and turbine stages shown in FIG. 1 were selected for illustrative purposes only, and that other numbers are possible.

In operation, the rotating fan 20 supplies ambient air to the LP compressor 24, which then supplies pressurized ambient air to the HP compressor 26, which further pressurizes the ambient air. The pressurized air from the HP compressor 26 is mixed with fuel in combustor 30 and ignited, thereby generating combustion gases. Some work is extracted from these gases by the HP turbine 34, which drives the HP compressor 26. The combustion gases are discharged into the LP turbine 36, which extracts additional work to drive the LP compressor 24, and the exhaust gas is ultimately discharged from the engine 10 via the exhaust section 38. The driving of the LP turbine 36 drives the LP spool 50 to rotate the fan 20 and the LP compressor 24.

Some of the ambient air supplied by the fan 20 may bypass the engine core 44 and be used for cooling of portions, especially hot portions, of the engine 10, and/or used to cool or power other aspects of the aircraft. In the context of a turbine engine, the hot portions of the engine are normally downstream of the combustor 30, especially the turbine section 32, with the HP turbine 34 being the hottest portion as it is directly downstream of the combustion section 28. Other sources of cooling fluid may be, but is not limited to, fluid discharged from the LP compressor 24 or the HP compressor 26.

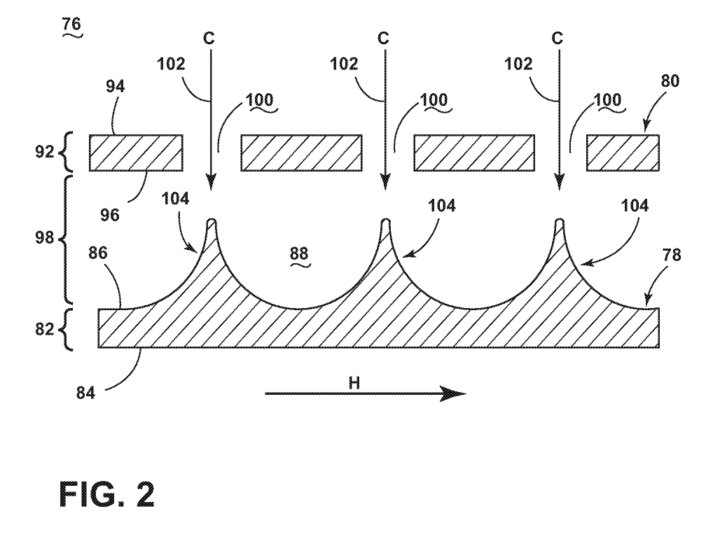

FIG. 2 is a schematic view showing an engine component assembly 76 of the engine 10 from FIG. 1 according to first embodiment of the invention. The engine component assembly 76 includes a first engine component 78 and a second engine component 80.

The first engine component 78 can be disposed in a flow of hot gases represented by arrows H. A cooling fluid flow, represented by arrows C may be supplied to cool the first engine component 78. As discussed above with respect to FIG. 1, in the context of a turbine engine, the cooling air can be ambient air supplied by the fan 20 which bypasses the engine core 44, fluid discharged from the LP compressor 24, or fluid discharged from the HP compressor 26. Some non-limiting examples of the first engine component 78 include a blade, a nozzle, vane, shroud, combustor liner, or combustor deflector.

The first engine component 78 includes a wall 82 having a hot surface 84 facing the hot combustion gas and a cooling surface 86 facing cooling fluid. The first engine component 78 can define at least one interior cavity 88 comprising the cooling surface 86. The hot surface 84 may be an exterior surface of the engine component 80. In the case of a gas turbine engine, the hot surface 84 may be exposed to gases having temperatures in the range of 1000° C. to 2000° C. Suitable materials for the wall 82 include, but are not limited to, steel, refractory metals such as titanium, or super alloys based on nickel, cobalt, or iron, and ceramic matrix composites. A protective coating, such as a thermal barrier coating, can be applied to the hot surface 84 of the first engine component 78.

The first engine component 78 can further include a plurality of film holes (not shown) that provide fluid communication between the interior cavity 88 and the hot surface 84 of the engine component 80. During operation, cooling air C is supplied to the interior cavity 88 and out of the film holes to create a thin layer or film of cool air on the hot surface 84, protecting it from the hot combustion gas H.

The second engine component 80 includes a wall 92 having a first surface 94 in fluid communication with the cooling fluid flow C and a second surface 96 that is spaced from the cooling surface 86 and defines a space 98 between the second surface 96 and the cooling surface 86. The wall 92 can be located within the interior cavity 88 of the first engine component 78, with the space 98 being formed from at least a portion of the interior cavity 88. Some non-limiting examples of the second engine component 80 include a wall, baffle, or insert within a blade, a nozzle, vane, shroud, combustor liner, or combustor deflector.

The second engine component 80 further includes one or more cooling aperture(s) 100 through which the cooling fluid flow C passes and is directed toward the cooling surface 86 of the first engine component 78. The cooling aperture 100 can extend orthogonally between the first and second surfaces 94, 96 of the second engine component 80, or can be oriented at an angle with respect to the surfaces 94, 96.

The cooling aperture 100 can define a streamline 102 for the cooling fluid flow C. The streamline 102 may be collinear with the centerline of the cooling aperture 100, particularly in cases where the cooling aperture 100 is circular or otherwise symmetrical, as in the illustrated embodiment. In case where the cooling aperture 100 is irregular or asymmetrical, the streamline 102 may diverge from the centerline.

At least one cooling feature 104 can extend from the cooling surface 86 of the first engine component 78. The cooling feature 104 increases the surface area of the cooling surface 86, allowing more heat to be removed from the first engine component 78, and also may increase the turbulence in the cooling air flow C. The cooling feature 104 can be shaped and oriented relative to the at least one cooling aperture 100 in order to locally produce a tangential or nearly tangential impact of the cooling fluid flow C on the cooling surface 86. A plurality of cooling features 104 can be provided on the cooling surface 86. A cooling aperture 100 can be provided for and dedicated to one cooling feature 104.

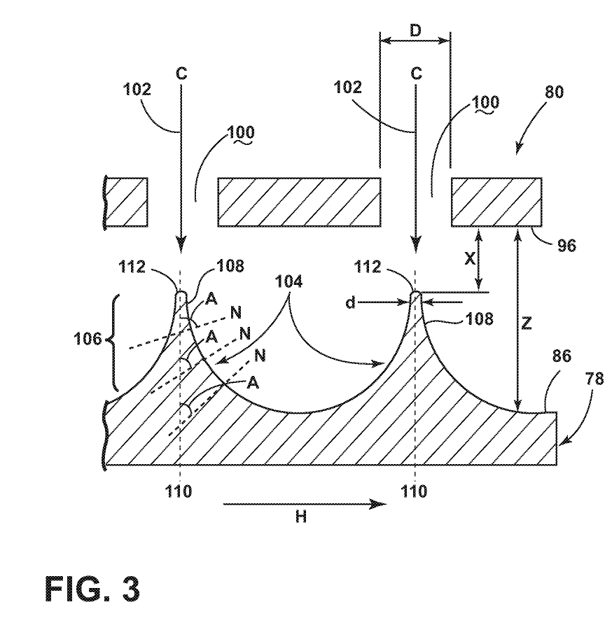

FIG. 3 is a close-up view of a portion of FIG. 2. In the illustrated embodiment, the at least one cooling feature 104 includes a body 106 with a perimetral wall 108. The body 106 of the cooling feature defines a body axis 110, and is shaped and oriented relative to the streamline 102 such that the streamline 102 is orthogonal to the body axis 110 and non-orthogonal to at least a portion of perimetral wall 108. This creates angled impingement in localized areas of the cooling surface 86, while still reducing or preventing particle accumulation, as described in further detail below. In the cross-section view of FIG. 3, the body axis 110 bisects the body 106.

The perimetral wall 108 can be contoured such that an angle between a local normal N on the perimetral wall 108 and the cooling fluid streamline 102 defines a local impingement angle A that is less than 90 degrees for at least some of the perimetral wall 108, where the local normal N is a line extending perpendicularly through the perimetral wall 108 at a localized area of the wall 108. The local impingement angle A can vary as the surface contour of the perimetral wall varies. In the illustrated embodiment, the local impingement angle A can be less than 90 degrees for the entire perimetral wall 108, but decreases in a direction away from the peak 112.

More specifically, in the illustrated embodiment the perimetral wall 108 terminates in a peak 112, with the body axis 110 extending through the peak 112. The body 106 is further shaped and oriented relative to the centerline of the at least one cooling aperture 100, which is collinear with the streamline 102, such that the centerline is orthogonal to the peak 112. As shown, all of the perimetral wall 108 can be non-orthogonal to the centerline.

In the illustrated embodiment, the cooling aperture 100 is aligned with the peak 112 of the cooling feature 104. In one embodiment, the distance (X) between the second surface 96 of the second engine component 80 and the peak 112 of the cooling feature 104 is at least ⅔ or less than the distance (Z) between the second surface 96 and the cooling surface 86 of the first engine component. Further, the peak 112 of the cooling feature 104 has an effective diameter (d) less than ½ of the diameter (D) of the cooling aperture 100.

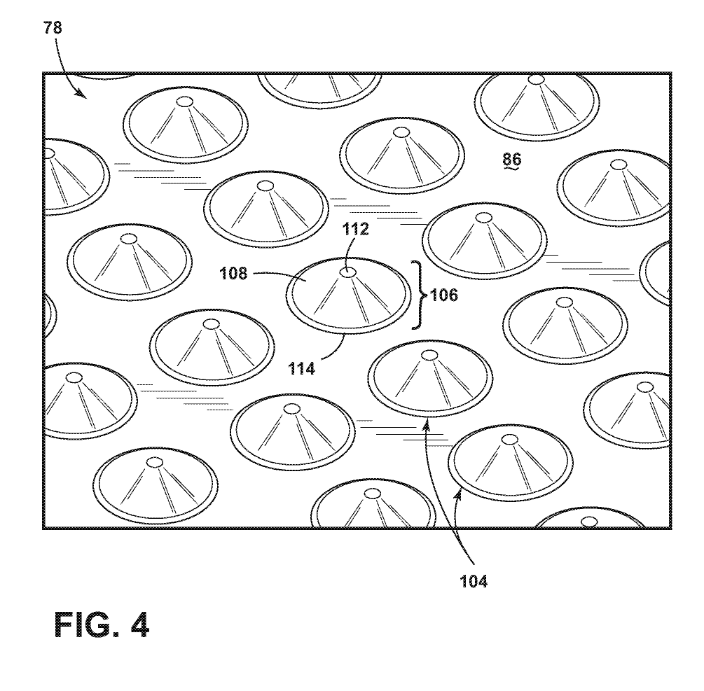

FIG. 4 is a perspective view of the cooling surface 86 of the first engine component 78. An array of cooling features 104 can be provided across the cooling surface 86. The body 106 of the cooling features 104 can be cone-shaped, with the perimetral wall 108 tapering smoothly to the peak 112, which comprises a point or apex.

The interface between the body 106 of the cooling feature 104 and the cooling surface 86 can define a transition 114. The transition 114 can be smooth as shown, or can be defined by a sharp edge between the cooling feature 104 and the cooling surface 86. A smooth transition may be preferable to avoid stagnation points on the cooling surface 86.

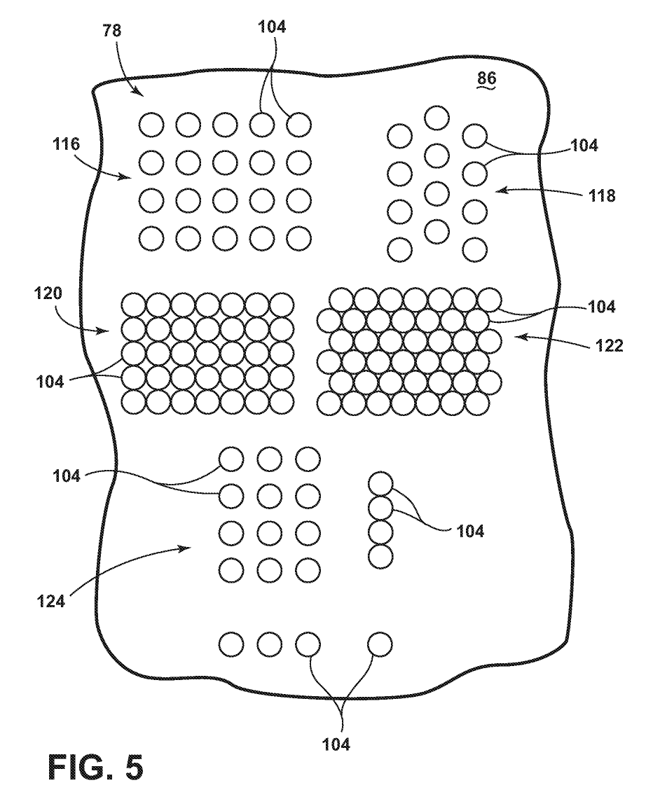

FIG. 5 is a plan view of the cooling surface 86 of the first engine component 78 showing some examples of arrays of cooling features 104 that can be provided on the cooling surface 86. The array may be arranged in accordance with some predetermined pattern, or may be irregular. For example: the array may be formed of rows of cooling features 104 extending in first and second directions; the cooling features 104 may be aligned or staggered; the cooling features 104 may further be spaced from each other or contiguous; and/or the spacing between the cooling features 104 may be constant or varied.

In the instant embodiment one array 116 is shown with uniform spacing between rows of aligned cooling features 104. Another array 118 is shown with uniform spacing between rows of staggered cooling features 104. Another array 120 is shown with aligned rows of contiguous cooling features 104. Another array 122 is shown with staggered rows of contiguous cooling features 104. Another array 124 is shown with varied spacing between rows of spaced and contiguous cooling features 104.

A plurality of arrays may be utilized on the first engine component 78 or a mixture of arrays with uniform size and/or shape may be utilized. A single array may be formed or alternatively, or a plurality of smaller arrays may be utilized along the cooling surface 86. The configuration of the array may be dependent upon locations where cooling is more desirable as opposed to utilizing a uniformly spaced array which provides generally equivalent cooling at all locations.

For each of the exemplary arrays shown in FIG. 5, a corresponding array of cooling apertures 100 (see FIG. 2) can likewise be provided on the second engine component 80. The corresponding array can include a cooling aperture 100 dedicated to one cooling feature 104.

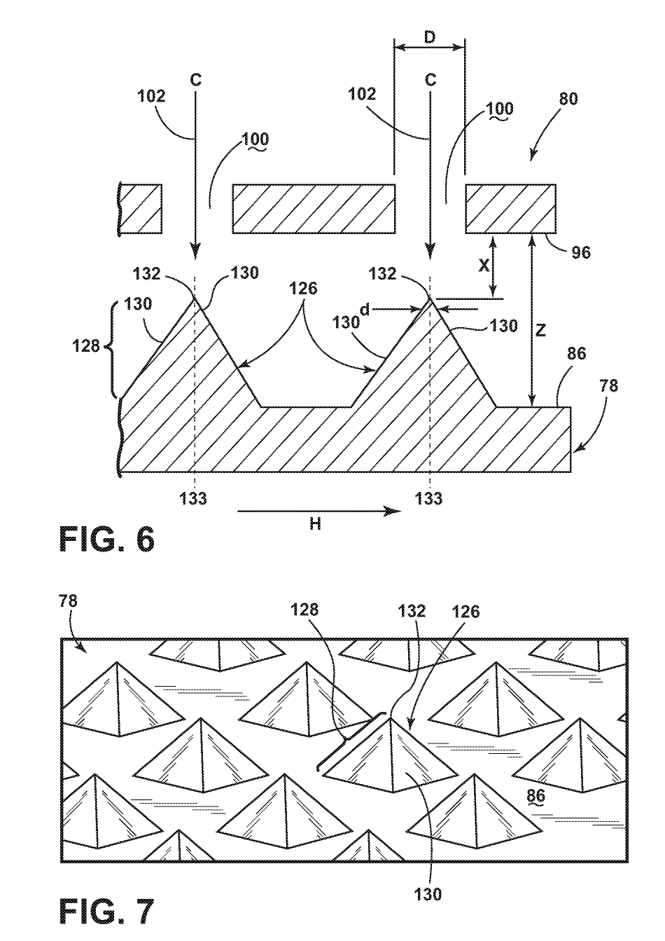

The cooling features 104, while illustrated as having a circular plan form, may have many other shapes. For example, FIGS. 6-11 are perspective views showing some other examples of cooling features that can be applied to the cooling surface 86 of the first engine component 78. The cooling features of FIGS. 6-11 can be applied in an array, such as the arrays shown in FIG. 4, and one cooling surface 86 may comprise one or more of the shapes shown herein.

In FIG. 6-7, the cooling surface 86 is provided with an array of cooling features 126 having a pyramid-shaped body 128, with a perimetral wall having triangular lateral surfaces 130 that converge to a peak, which comprises a point or apex 132. In this case, the pyramid-shaped body 128 can define a body axis 133 that extends through the apex 132, and in the cross-section view of FIG. 6, bisects the body 128. The body axis 133 can be shaped and oriented relative to the streamline 102 such that it is orthogonal to the streamline 102 and extends through the apex 132. The streamline 102 is further non-orthogonal to the lateral surfaces 130.

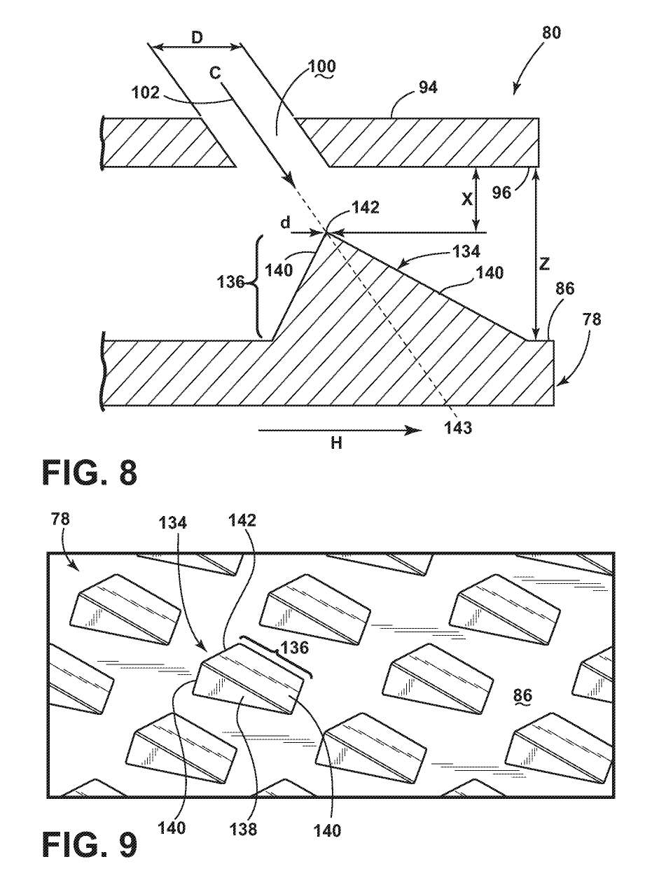

In FIGS. 8-9, the cooling surface 86 is provided with an array of cooling features 134 having a wedge-shaped body 136, with a perimetral wall having opposing pairs of triangular lateral surfaces 138 and rectilinear lateral surfaces 140 that converge to a peak, which comprises a ridge 142. In this case, the wedge-shaped body 136 can define a body axis 143 that extends through the ridge 142, and in the cross-section view of FIG. 8, bisects the body 136. Further, the cooling aperture 100 is oriented at an angle with respect to the surfaces 94, 96 of the second engine component 80 to define an angled streamline 102. The body axis 143 can be shaped and oriented relative to the streamline 102 such that it is orthogonal to the streamline 102 and extends through the ridge 142. The streamline 102 is further non-orthogonal to at least one of the rectilinear lateral surfaces 140.

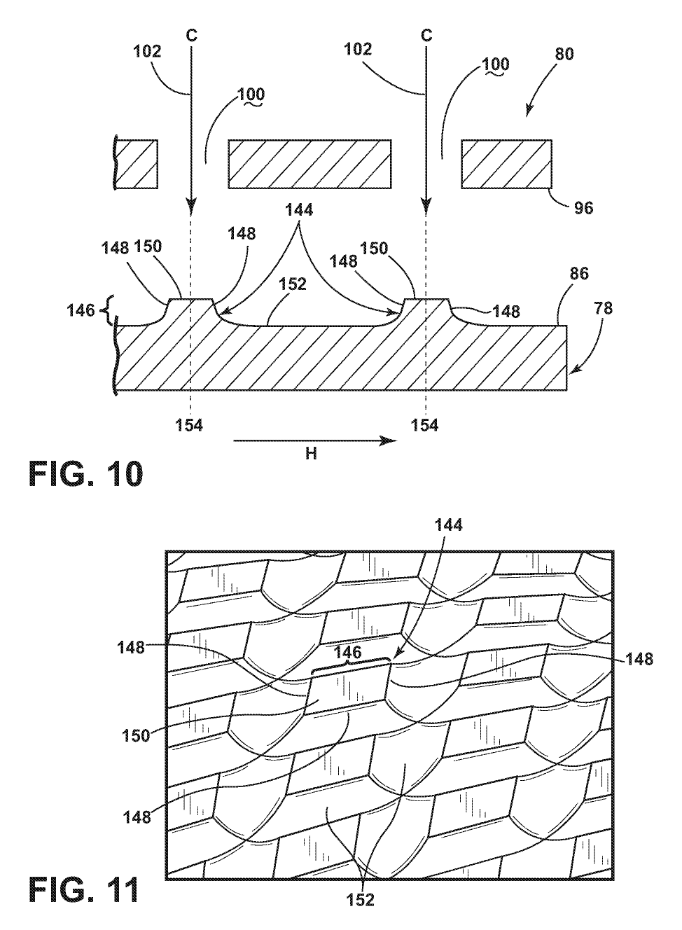

In FIGS. 10-11, the cooling surface 86 is provided with an array of cooling features 144 having a diamond-shaped body 146, with a perimetral wall having concavely-curved sides 148 that converge to a peak, which comprises a planar surface 150. The array of bodies 146 can be formed by intersecting channels 152 in the cooling surface 86. In this case, the diamond-shaped body 146 can define a body axis 154 that extends through the planar surface 150, and in the cross-section view of FIG. 10, bisects the body 146. The body axis 154 can be shaped and oriented relative to the streamline 102 such that it is orthogonal to the streamline 102 and extends through the planar surface 150. The streamline 102 is further non-orthogonal to the concavely-curved sides 148.

In any of the above embodiments, it is understood that the drawings may not be to scale, particularly with respect to the relative sizes of the first and second components 78, 80, cooling apertures 100, and the various cooling features 104, 126, 134, 144. The size of certain components may be exaggerated for clarity in the drawings.

The various embodiments of systems, methods, and other devices related to the invention disclosed herein provide improved cooling for turbine engine components. One advantage that may be realized in the practice of some embodiments of the described systems is that dust accumulation on cooled engine components can be reduced or eliminated. Some engine components are reliant on impingement of cooling fluid on the surface of the component opposite the surface exposed to the hot combustion gas in order to maintain an acceptable metal temperature and meet life requirements. Prior designs relying on impingement cooling typically direct a high-velocity air jet at an angle normal (90 degrees) to the cooling surface in combination with cast-in raised features on the cooling surface, such as bumps on HP turbine shrouds. However, the 90 degree impingement creates a stagnation location at the strike point of the air jet on the cooling surface. This stagnation region collects particles, which acts as an insulator on the shroud. Raised features on the cooling surface may increase the amount of dust that accumulates on the component, further reducing the ability for the part to be cooled by impingement. Directing the impingement at an angle to the surface of the component can reduce stagnation, but by angling the air jet the heat transfer coefficient associated with the array impingement is reduced.

The present invention overcomes these deficiencies by using a normal impingement design for the cooling apertures in combination with a contoured cooling surface to locally produce an angled impact of cooling air flow rather than a normal impact, which reduces or eliminates dust accumulation while maintaining component cooling effectiveness. This effectiveness can increase the time-on-wing (TOW) for the turbine engine and the service life of these parts can be increased.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. An engine component assembly, comprising:
a first engine component having a hot surface in thermal communication with a hot combustion gas flow and a cooling surface, with the cooling surface being different than the hot surface;
a second engine component having a first surface in fluid communication with a cooling fluid flow and a second surface, different from the first surface, spaced from the cooling surface and defining a space between the second surface and the cooling surface;
at least one cooling aperture defining a centerline and extending through the second engine component from the first surface to the second surface; and
at least one cooling feature extending from the cooling surface of the first engine component and having a body with a perimetral wall terminating in a peak;
wherein the body is oriented relative to the centerline such that the centerline is orthogonal to the peak and non-orthogonal to at least a portion of perimetral wall.

2. The engine component assembly of claim 1 wherein the first engine component comprises at least one of a nozzle, a vane, a blade, a shroud, a combustor liner, or a combustor deflector.

3. The engine component assembly of claim 1 wherein the second engine component comprises a wall located within an interior of the first engine component.

4. The engine component assembly of claim 3 wherein the space between the second surface and the cooling surface is formed from at least a portion of the interior of the first engine component.

5. The engine component assembly of claim 3 wherein the wall comprises an insert located within the interior of the first engine component and the at least one cooling aperture extends through the insert.

6. The engine component assembly of claim 1 wherein the body is shaped and oriented such that all of the perimetral wall is non-orthogonal to the centerline.

7. The engine component assembly of claim 1 wherein an interface between the body and the cooling surface of the first engine component defines a transition.

8. The engine component assembly of claim 7 wherein the transition is smooth.

9. The engine component assembly of claim 1 wherein the centerline extends orthogonally between the first and second surfaces of the second engine component.

10. The engine component assembly of claim 1 further comprising a plurality of cooling features.

11. The engine component assembly of claim 10 wherein at least some of the plurality of cooling features have a dedicated cooling aperture.

12. The engine component assembly of claim 10 comprising at least one cooling aperture for each of the plurality of cooling features.

13. The engine component assembly of claim 10 further comprising an array of cooling features in the first engine component.

14. The engine component assembly of claim 10 wherein the plurality of cooling features are spaced from each other.

15. The engine component assembly of claim 14 wherein the distance between the second surface of the second engine component and at least one of the plurality of cooling features is at least ⅔ or less than the distance between the cooling surface of the first engine component and the second surface of the second engine component.

16. The engine component assembly of claim 15 wherein the peaks of the plurality of cooling features have an effective diameter less than ½ of the diameter of the at least one cooling aperture.

17. The engine component assembly of claim 10 wherein the plurality of cooling features are arranged in rows.

18. The engine component assembly of claim 17 wherein at least some of the rows intersect each other.

19. The engine component assembly of claim 18 further comprising intersecting channels in the cooling surface of the first engine component which form the rows of cooling features.

20. The engine component assembly of claim 1 wherein the body generally comprises a cone, a pyramid, or a wedge.

21. The engine component assembly of claim 20 wherein the body comprises a ridge.

22. The engine component assembly of claim 1 wherein the peak comprises a point.

23. The engine component assembly of claim 22 further comprising a plurality of cooling features terminating in a point.

24. The engine component assembly of claim 23 wherein the plurality of cooling features are contiguous.

25. The engine component assembly of claim 1 wherein the peak comprises a ridge.

26. The engine component assembly of claim 25 further comprising a plurality of cooling features terminating in a ridge.

27. The engine component assembly of claim 26 wherein the plurality of cooling features are contiguous.

28. An engine component assembly, comprising:
a first engine component having a hot surface in thermal communication with a hot combustion gas flow and a cooling surface, with the cooling surface being different than the hot surface;
a second engine component having a first surface in fluid communication with a cooling fluid flow and a second surface, different from the first surface, spaced from the cooling surface and defining a space between the second surface and the cooling surface;
at least one cooling aperture extending through the second engine component from the first surface to the second surface and defining a cooling fluid flow path defining a cooling fluid streamline; and
at least one cooling feature extending from the cooling surface of the first engine component and comprising a body defining a body axis and having a perimetral wall;
wherein the body is oriented relative to the cooling fluid flow path such that the cooling fluid streamline is orthogonal to the body axis and non-orthogonal to at least a portion of perimetral wall.

29. The engine component assembly of claim 28 wherein the first engine component comprises at least one of a nozzle, a vane, a blade, a shroud, a combustor liner, or a combustor deflector.

30. The engine component assembly of claim 28 wherein the second engine component comprises a wall located within an interior of the first engine component.

31. The engine component assembly of claim 30 wherein the space between the second surface and the cooling surface is formed from at least a portion of the interior of the first engine component.

32. The engine component assembly of claim 30 wherein the wall comprises an insert located within the interior of the first engine component and the at least one cooling apertures extends through the insert.

33. The engine component assembly of claim 28 wherein the body is shaped and oriented such that all of the perimetral wall is non-orthogonal to the cooling fluid streamline.

34. The engine component assembly of claim 28 wherein an interface between the body and the cooling surface of the first engine component defines a transition.

35. The engine component assembly of claim 34 wherein the transition is smooth.

36. The engine component assembly of claim 28 wherein the cooling fluid streamline extends orthogonally between the first and second surfaces of the second engine component.

37. The engine component assembly of claim 28 further comprising a plurality of cooling features.

38. The engine component assembly of claim 37 wherein at least some of the plurality of cooling features have a dedicated cooling aperture.

39. The engine component assembly of claim 37 comprising at least one cooling aperture for each of the plurality of cooling features.

40. The engine component assembly of claim 37 further comprising an array of cooling features in the first engine component.

41. The engine component assembly of claim 37 wherein the plurality of cooling features are spaced from each other.

42. The engine component assembly of claim 41 wherein the distance between the second surface of the second engine component and at least one of the plurality of cooling features is at least ⅔ or less than distance between the cooling surface of the first engine component and the second surface of the second engine component.

43. The engine component assembly of claim 42 wherein plurality of cooling features each terminates in a peak having an effective diameter less than ½ of the diameter of the at least one cooling aperture.

44. The engine component assembly of claim 37 wherein the plurality of cooling features are arranged in rows.

45. The engine component assembly of claim 44 wherein at least some of the rows intersect each other.

46. The engine component assembly of claim 45 further comprising intersecting channels in the cooling surface of the first engine component which form the rows of cooling features.

47. The engine component assembly of claim 28 wherein the body generally comprises a cone, a pyramid, or a wedge.

48. The engine component assembly of claim 28 wherein the body comprises a ridge.

49. The engine component assembly of claim 28 wherein an angle between a local normal on the perimetral wall and the cooling fluid streamline defines a local impingement angle.

50. The engine component assembly of claim 49 wherein the local impingement angle is less than 90 degrees for at least some of the perimetral wall.

51. The engine component assembly of claim 50 wherein the local impingement angle is less than 90 degrees for all of the perimetral wall.

52. The engine component assembly of claim 28 wherein the perimetral wall terminates in a point.

53. The engine component assembly of claim 52 further comprising a plurality of cooling features terminating in a point.

54. The engine component assembly of claim 53 wherein the plurality of cooling features are contiguous.

55. The engine component assembly of claim 28 wherein the perimetral wall terminates in a ridge.

56. The engine component assembly of claim 55 further comprising a plurality of cooling features terminating in a ridge.

57. The engine component assembly of claim 56 wherein the plurality of cooling features are contiguous.
